(19) United States
(12) Patent Application Publication
(10) Pub. No.: US 2007/0121822 A1
(43) Pub. Date: May 31, 2007

(54) Methods and apparatus to allow multiple clients to access a computer telephony interface server

(76) Inventors: Victor Carnale, Wallingford, CT (US); Naresh Shetty, Hamden, CT (US); Robert Samokar, North Haven, CT (US); Vamsi Chintapalli, West Haven, CT (US); Cathy Vitelli, Orange, CT (US); Jack Sutton, Madison, CT (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/264,718

(22) Filed: Nov. 1, 2005

(51) Int. Cl. H04M 11/00

(52) U.S. Cl. 379/88.14

(57) ABSTRACT

CTI servers capable of communicating with multiple clients and methods of operating the same are disclosed. An example system includes a client handler to receive messages from the multiple clients, a message handler to change the format of the messages, a queue to store messages, an interface to a telephony network, a data processor to generate responses to messages, and a CTI driver to retrieve messages from the queue and pass the retrieved messages to the data processor, and a data storage to store data associated with the messages.

### FIELD OF THE DISCLOSURE

This disclosure relates generally to computer telephony systems, and, more particularly, to systems for allowing multiple clients to access a computer telephony interface server.

### BACKGROUND

Recently, there has been an increased desire to integrate computer systems with the telephony infrastructure that already exists. One system for accomplishing such an integration is a computer telephony interface (CTI) server. One example CTI server is the I-Server from Genesys Telecommunication Laboratories, Inc. The CTI server is capable of communicating with telephone calls and user interface clients to allow management of calls and data associated with calls. Example user interface clients include enterprise access service layer (EASL) applications, Perifonics (PERI) applications, call setup applications, etc. For example, incoming telephone calls directed to a CTI server can use an interactive voice response (IVR) module of the CTI server to send data to the CTI server for storage or retransmission to a user interface client. The IVR may play recorded messages to a caller and receive responses entered by the caller on a touchtone telephone keypad or may receive voice responses which can be converted to text. The caller can additionally request data that has been authorized for distribution to callers.

The user interface client allows users of a CTI server to examine data that is stored in the CTI server. For example, a caller may call a company's call center to request support for telephone services provided by the company. When the call is received, the CTI server can retrieve records associated with the caller (e.g., a telephone number from which the caller has called or associated with a number that the caller has entered via an IVR module). The records may indicate which features the caller has paid for and/or any other data associated with the user's account. When the call is routed to an agent of the company's call center, the agent's computer will display the records retrieved so that the agent can be informed about the caller's features and/or account.

While it is often desired to have many agents in a call center receiving calls, a CTI server typically supports a single request. For example, a CTI server only has a single socket with which it can accept connections. Therefore, typically a single user interface client can connect to send requests at a time.

In addition, a CTI server typically supports a single connection interface that utilizes strict formatting for requests. Thus, typically, user interface clients must support the connection interface used by the CTI server and must be very familiar with the specifications of the CTI server to be able to communicate with the CTI server.

### BRIEF DESCRIPTION OF DRAWINGS

FIG. 1 is a block diagram of an example computer telephony interface (CTI) server.

FIG. 2 is a block diagram of a system for allowing multiple clients to connect to a CTI server simultaneously.

FIG. 3 is a block diagram of an example implementation of the client handler of FIG. 2.

FIG. 4 is a block diagram of an example implementation of the message handler of FIG. 2.

FIG. 5 is a block diagram of an example implementation of the queue handler of FIG. 2.

FIG. 6 is a block diagram of an example implementation of the CTI driver of FIG. 2.

FIG. 7 is a flow diagram representative of machine readable instructions that may be executed to implement the client handler, message handler, and queue handler of FIG. 2.

FIG. 8 is a flow diagram representative of machine readable instructions that may be executed to implement the CTI driver of FIG. 2.

FIG. 9 is a flow diagram illustrating how a request to initialize a new call may be handled by the system of FIG. 2.

FIG. 10 is a flow diagram illustrating how a request to end a call may be handled by the system of FIG. 2.

FIG. 11 is a flow diagram illustrating how a request to obtain a call routing number may be handled by the system of FIG. 2.

FIG. 12 is a flow diagram illustrating how a request to transfer a call to another CTI system may be handled by the system of FIG. 2.

FIG. 13 is a flow diagram illustrating how a message to attach data to a call may be handled by the system of FIG. 2.

FIG. 14 is a flow diagram illustrating how a message to retrieve data associated with a call may be handled by the system of FIG. 2.

FIG. 15 is a block diagram of another example system for allowing multiple clients to connect to a CTI server simultaneously.

FIG. 16 is a block diagram of an example computer capable of executing the machine readable instructions represented by FIGS. 7 and 8 to implement the apparatus and/or methods disclosed herein.

### DETAILED DESCRIPTION

Methods and apparatus to allow multiple clients to access a computer telephony interface (CTI) server are provided. An example system comprises a client handler to receive messages from the multiple clients, a message handler to change the format of the messages, a queue to store messages, an interface to a telephony network, a data processor to generate responses to messages, and a CTI driver to retrieve messages from the queue and pass the retrieved messages to the data processor, and a data storage to store data associated with the messages. Accordingly, the illustrated methods and apparatus allow multiple clients to access a CTI server even if the CTI server only allows a limited number of simultaneous connections.

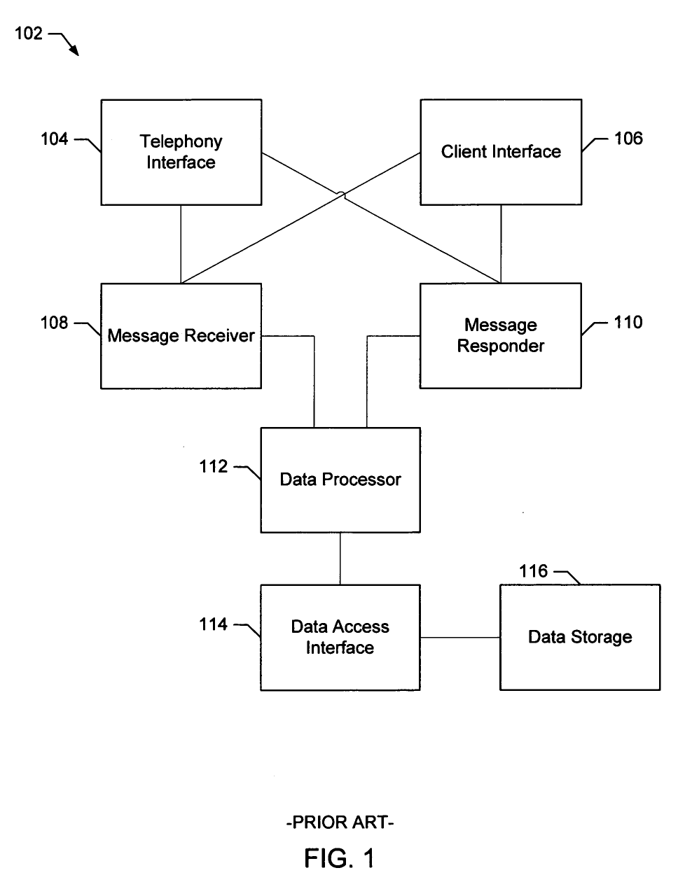

FIG. 1 is a block diagram of an example computer telephony interface (CTI) server 102. The example CTI server 102 includes a telephony interface 104, a client interface 106, a message receiver 108, a message responder 110, a data processor 112, a data access interface 114, and data storage 116. In general, the CTI server 102 receives messages from telephone calls or user interface clients and generates responses to the messages. The responses are communicated to the telephone call or user interface client that generated the request.

The telephony interface 104 may be any connection to a telephony network capable of transferring messages between the CTI server 102 and the telephony network. For example, the telephony interface 104 may be a connection to a public switched telephony network (PSTN), a network connection to a Voice Over IP Network (VoIP), or any other connection that is or may be associated with a telephony network. The telephony interface 104 of the illustrated example is capable of receiving input from phone calls and transmitting the input to the message receiver 108. For example, the telephony interface 104 may receive numbers input using a telephone keypad (e.g., dual tone multi frequency (DTMF) signal input), voice-commands, digital communications, or any other input. The telephony interface 104 may include any module(s) necessary for handling inputs received from the telephony network. For example, the telephony interface 104 may include a voice communications module to handle voice-commands. The telephony interface 104 of the illustrated example is additionally capable of transmitting messages received from the message responder 110 to other devices on the telephony network (e.g., to the phone of the caller). For example, the telephony interface 104 may include a text-to-speech module to convert text data to spoken words, a data communications module, or any other method of transmitting messages to the caller interfacing with the telephony interface 104.

The client interface 106 of the illustrated example is capable of connecting the example CTI server 102 to a user interface client. A user interface client is capable of sending requests for data to the CTI server 102, receiving data from the CTI server 102, and presenting the data from the CTI server 102 to a user. The client interface 106 receives messages from connected user interface clients and transmits the messages to the message receiver 108. When message response(s) are received from the message responder 110, the client interface 106 communicates the response(s) to the user interface client. The example client interface 106 includes a single communications socket, which limits the example CTI server 102 to connecting to one client at a time. The client interface 106 may alternatively have more than one communications socket, but the number of communications sockets will typically be significantly less than the number of user interface clients that want to connect simultaneously. The client interface 106 may be any type of connection capable of connecting to user interface clients such as, for example, a wired network connection, a wireless network connection, a dial-up data connection, a universal serial bus connection, a FireWire connection, etc.

The message receiver 108 of the illustrated example receives messages from the telephony interface 104 and the client interface 106. Example messages may include a request to initialize a new call, a request for information about a call, a request to end a call, a message indicating how to route a call, a request to initiate a call route, etc. The message receiver 108 parses the message(s) to determine the message type and extracts any parameters that are associated with the message(s). The message receiver 108 sends the message type and the parameters to the data processor 112.

The data processor 112 of the illustrated example receives parsed message(s) from the message receiver 108, performs whatever function is required by the message(s), and sends the response to the message responder 110. The data processor 112 requests additional data from the data access interface 114, if necessary to handle the message(s). For example, if a message is received that requests information about a caller and supplies a social security number, the data processor 112 will make a request to the data access interface 114 to retrieve the record associated with the social security number from the data storage 116. The data processor 112 will then assemble a response and send the response to the messages responder 110. The data processor 112 additionally tracks the status of calls based on messages received from the message receiver 108. The data processor 112 sends the status of calls to the data access interface 114 for storage in the data storage 116.

The data access interface 114 of the illustrated example receives requests for data from the message processor 112, retrieves the data from the data storage 116, and returns the data to the message processor 112. The data access interface 114 may be any connection capable of communicating with the data storage 116. For example, the data access interface 114 may be a wired network connection, a wireless network connection, a dial-up data connection, a universal serial bus connection, a FireWire connection, etc. The data storage 116 may be any system capable of storing data such as, for example, a database, one or more files, etc.

The message responder 110 receives from the data processor 112 response(s) to message(s) received by the message receiver 108. The message responder 110 forms the response(s) into a message and transmits the message to the telephony interface 104 and/or the client interface 106.

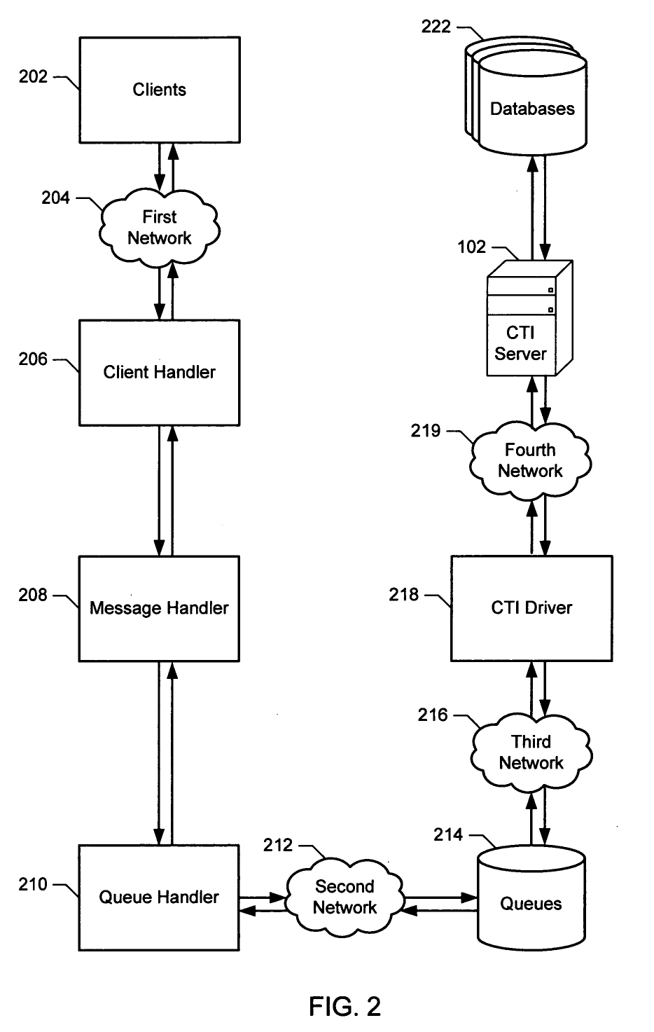

FIG. 2 is a block diagram of a system for allowing multiple clients 202 to simultaneously connect to CTI server 102102 of FIG. 1. The example system includes, a first network 204, a client handler 206, a message handler 208, a queue handler 210, a second network 212, queue(s) 214, a third network 216, a CTI driver 218, a fourth network 219, CTI server 102 and databases 222.

Any of the clients 202 may be any user interface client that is capable of transmitting messages. The clients 202 may be IVR software applications that are capable of transmitting requests to a CTI server. For example, the clients 202 may be any one of, or combination of, an enterprise access service layer (EASL) client, a Perifonics (PERI) applications client, a call setup application, etc. Example clients 202 may include client software running on multiple computer terminals in a telephone call-center. As calls are received in the call-center, information is collected from the call, and the call is routed to one of the clients 202. The one of the clients 202 may request further information about the call by sending a message over the network 204 to the client handler 206. The message may include some or all of the information that was collected from the call.

The first network 204 of the illustrated example may be any type of communication connection between the clients 202 and the client handler 206. The first network 204 may be a local area network (LAN) or a wide area network (WAN) depending on the locations of the clients 202 and the client handler 206. The first network 204 may not be necessary if, for example, the clients 202 are configured to run on the same system as the client handler 206.

The example client handler 206 (also known as the service interaction layer) handles communication with the clients 202. The example client handler 206 supports multiple communication protocols and can communicate with multiple clients simultaneously. For example, the client handler 206 may support an Enterprise Java Beans (EJB) interface, a Web Services interface, a Hypertext Transfer Protocol (HTTP) interface, a Simple Object Access Protocol (SOAP) interface, a servlet interface, a Java Messaging Service (JMS) interface, etc. In the illustrated example, the messages received from the clients 202 are in extensible markup language (XML) format. However, the messages may be in any other format including hypertext markup, plain text, comma separated format, tab-delimited format, etc.

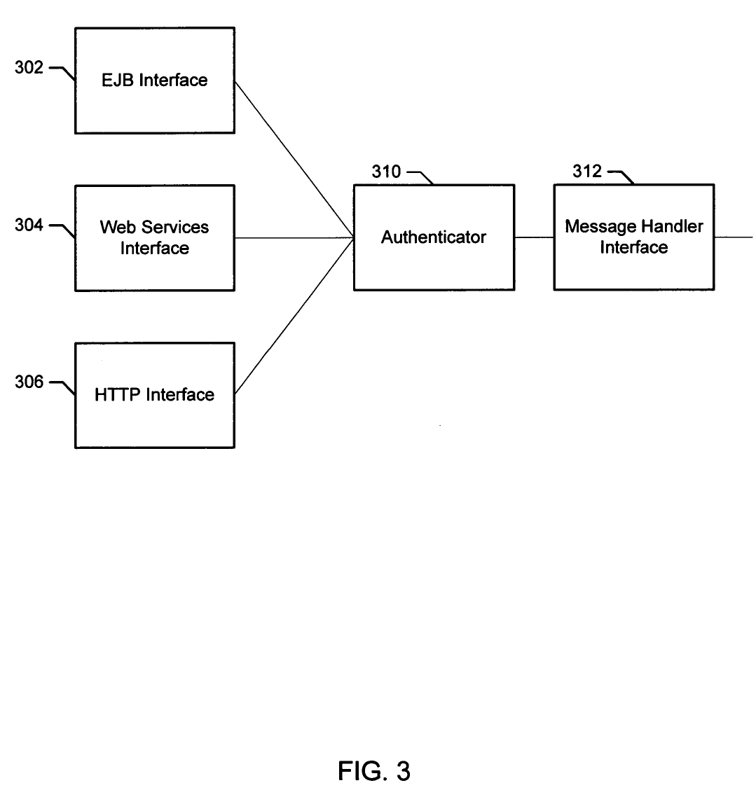

Messages received by the client handler 206 are transferred to the message handler 208. After receiving a message from one of the clients 202, the client handler 206 blocks the one of the clients 202 to cause the one of the clients 202 to wait for a response. Once a response is received from the message handler 208, the client handler 206 unblocks the one of the clients 202 and transfers the response to the one of the clients 202. The example client handler 206 additionally includes the ability to authenticate with clients 202 to ensure that only authorized ones of the clients 202 are allowed to connect. Authentication may be accomplished by the use of username/password, exchange of security keys or certificates, etc. The example client handler 206 is described in further detail in conjunction with FIG. 3.

The message handler 208 (also known as the Business Logic Layer) receives messages and performs validation and processing on the messages to prepare them for receipt by the CTI server 102. The message handler 208 also processes responses from the CTI server 102 for transmission to the clients 202 by the client handler 206. Irrespectively, when a message is received from the client handler 206, the message handler 208 validates the message to ensure that it does not contain errors. For example, if the message is in XML format, the client handler 206 of the illustrated example will ensure that all open tags include corresponding closing tags (e.g., an open tag such as <ITEM> should include the closing tag </ITEM>). As another example, the client handler 206 of the illustrated example ensures that all necessary components of the message are present, such as a header with the message structure/format, a purpose for the message, and a body of the message containing any parameters to be included with the message. If errors are found in the message, the message handler 208 of the illustrated example rejects the message and returns an error to the client via the client handler 206. Alternatively, the example message handler 208 may perform any necessary functions to fix the message.

The client handler 206 of the illustrated example additionally processes the message to ensure that it is in a format and structure suitable for reception by the CTI server 102. For example, if the message is not in an XML format and the CTI server 102 requires messages to be in an XML format, the example message handler 208 converts the message to XML format. Thus, the clients 202 and the CTI server 102 do not need to be associated with the same format because the message handler 208 can handle conversion from a first format to a second format and vice versa. The message handler 208 of the illustrated example operates according to the document object model (DOM) when handling XML messages. Once messages are properly structured/formatted, they are transmitted to the queue handler 210.

When a response is received from the CTI server 102 via the queue handler 210, the message handler 208 of the illustrated example verifies that the response is in a format suitable for reception by the clients 202. If the response is not in a suitable format, the illustrated-example message handler 208 converts the message to the appropriate format. The example message handler 208 transmits the response to the client handler 206 for transmission to the clients 202.

The example queue handler 210 (also known as the resource management layer) of FIG. 2 receives messages from the message handler 208 and puts them on the queue(s) 214. The example queue handler 210 also receives responses from the queue(s) 214 and transmits them to the message handler 208. When a message is received, the queue handler 210 of the illustrated example writes the message to a queue associated with the destination of the message. If there is only one CTI server 102, then the queue handler 210 places the message on the queue associated with the CTI server 102. If there are multiple CTI servers 220, then the queue handler 210 of the illustrated example identifies one of the queue(s) 214 that is associated with the CTI server 102 that is the destination of the message. The example queue handler 210 determines the destination of a message by examining the contents of the message or parameters associated with the message. For example, the example queue handler 210 of FIG. 2 determines the destination of the message by extracting a TMS number from the message and determining a CTI server that is associated with the extracted TMS number.

The queue handler 210 of the illustrated example also monitors the queue(s) 214 for the presence of a response to a message. When a response is on one of the queue(s) 214, the queue handler 210 retrieves the response and transmits it to the message handler 208. The queue handler 210 of the illustrated example monitors all of the queue(s) 214 for any message. Alternatively, the example queue handler 210 may monitor a subset of the queue(s) 214 or a subset of the messages that are on the queue(s) 214. For example, the queue handler 210 may monitor a subset of the queues or may monitor for messages that are associated with a subset of the clients 202.

In the example of FIG. 2, the second network 212 facilitates communication between the queue handler 210 and the queue(s) 214. The second network 212 may be different from, similar to, or the same as the first network 204. The second network 212 may not be present if, for example, the queue handler 210 and the queue(s) 214 are located in the same system.

The queue(s) 214 may be implemented by any type of storage capable of operating as a queue. For example, any or all of the queue(s) 214 may comprise one or more databases (e.g., a MQ Series database, a Tuxedo database, or any other type of database), one or more files, a TCP/IP stack, etc. The queue(s) 214 may comprise a plurality of queues each of which is respectively associated with a corresponding one of a plurality of CTI servers, a single queue associated with a single CTI server, a single queue associated with a plurality of CTI servers, multiple queues associated with each of a plurality of CTI servers, or any other combination of queues and CTI servers. For instance, each of a plurality of CTI servers may include a first queue dedicated to messages that are in route to the CTI server and a second queue dedicated to responses that are in route from the CTI server 220 to the clients.

The third network 216 of the illustrated example facilitates communication between the queue(s) 214 and the CTI driver 218. The third network 216 may be different from, similar to, and/or the same as the first network 204 and/or the second network 212. The third network 216 may not be present if, for example, the queue(s) 214 are in the same system as the CTI driver 218.

The CTI driver 218 of the illustrated example retrieves messages from the queue(s) 214 and transmits the messages to the CTI server 102 and receives responses from the CTI server 102. The CTI driver 218 also stores the responses in the queue(s) 214 associated with the CTI server 102. The CTI driver 218 monitors the queue(s) 214 for a message that is directed to the CTI server 102 with which the CTI driver 218 is connected. When such a message is located on the corresponding queue(s) 214, the CTI driver 218 of the illustrated example retrieves the message from the queue(s) 214 and sends the message to the CTI server 102 via the fourth network 219. The example CTI driver 218 locates the message on the queue(s) 214 by periodically polling the queue(s) 214 to request the next message to be handled. Additionally or alternatively, the CTI driver 218 may employ other methods of determining when messages are waiting on the queue(s) 214. For example, the CTI driver may receive a broadcast from the queue(s) 214 indicating that messages are waiting, may examine a bit or flag that indicates when messages are waiting, etc. The CTI driver 218 may monitor one queue 214 or may monitor multiple queue(s) 214. For example, the CTI driver 218 may be associated with a single CTI server and may only retrieve messages from a queue that is associated with that CTI server. Alternatively, the CTI driver 218 may monitor multiple ones of the queue(s) 214, but may only retrieve messages that are associated with a single CTI server by checking a parameter associated with the messages. Of course, persons of ordinary skill in the art will readily appreciate that other monitoring apparatus are likewise appropriate.

When the CTI server 102 of the illustrated example generates a response to a message, the response is sent to the CTI driver 218 via the network 219. The CTI driver 218 receives the response and prepares a message (e.g., marshals the response) for retransmission to the queue(s) 214. The example CTI driver 218 of the illustrated example determines when the CTI server 102 is ready to transmit a response by monitoring for a broadcast from the CTI server 102 that a response is ready. Alternatively or additionally, the CTI driver 218 may periodically poll the CTI server 102 to determine when a response is ready. In addition to the response, the CTI driver 218 of the illustrated example receives a CallID if one is sent by the CTI server 102. The CTI driver 218 uses the CallID to generate a CorrelationID to associate with the response and/or the call that is associated with the response (i.e., the call that is associated with the message to which the response is replying). The CorrelationID is used to identify the response in the queue(s) 214. Alternatively, any other scheme of identifying responses and associating them with messages and calls may be used. The response is placed on one of the queue(s) 214 that is associated with the CTI server 102. Alternatively, any other scheme may be used to determine which queue to place the response on or a single queue may be utilized. The CorrelationID is placed on the queue(s) 214 and associated with the response. The response then sits on the queue and awaits retrieval by the queue handler 210.

In the illustrated example, the fourth network 219 facilitates communication between the CTI driver 218 and the CTI server 102. The fourth network 219 may be different from, similar to, and/or the same as the first network 204, the second network 212, and/or the third network 212. The fourth network 219 may not be present if, for example, the CTI driver 218 and the CTI server 102 are in the same system.

When the CTI server 102 of the illustrated example receives a message, the CTI server 102 processes the message, retrieves any necessary data from the databases 222, and generates a response for transmission to the CTI driver 218.

The databases 222 of the illustrated example store information that may be accessed by the CTI server 102 in order to response to messages. For example, the databases 222 of the illustrated example store information about customers so that the CTI server 102 may obtain a customer's record and associate the record with the call in response to a call from the customer. The databases 222 may be any type of data storage capable of storing information that may be used by the CTI server 102. For example, the databases 222 may be one or more databases, one or more files stored on a computer, etc. The databases 222 may be external to the CTI server 102, may be located in the same or a different geographical location than the CTI server 102, and/or may be integrated into the CTI server 102.

The system illustrated in FIG. 2 shows multiple components as separate pieces of an entire system. It should be understood that some or all of these components may be integrated together. For example, the entire system may be integrated into a single CTI server with or without the clients 202. As a first example, the client handler 206, the message handler 208 and the queue handler 210 may be integrated as a single component. As a second example, the client handler 206, the message handler 208, the queue handler 210, and the CTI driver 218 may be integrated as a single component. As a third example, the client handler 206, the message handler 208, the queue handler 210, the CTI driver 218, and the CTI server 102 may be integrated as a single component. While several example configurations are provided herein, this list of configurations is not intended to be an exhaustive list. Any integration of components or lack thereof may be utilized.

FIG. 3 is a block diagram of an example implementation of the client handler 206 of FIG. 2. The example client handler 206 includes an Enterprise Java Beans (EJB) interface 302, a Web Services Interface 304, a Hypertext Transfer Protocol (HTTP) interface 306, an authenticator 310, and a handler interface 312.

The EJB interface 302, Web Services interface 304, and the HTTP interface 306 of the illustrated example provides connection to clients. Including multiple interface types allows the example client handler 206 to communicate with multiple types of clients. The EJB interface 302 provides support for clients that support Java 2 Platform, Enterprise Edition (J2EE). The EJB interface 302 is capable of handling work load management, scalability, and fault tolerance. The Web Services interface 304 provides support to clients that support programmable application logic using standard internet protocols. The HTTP interface 306 provides support for clients that don't support either of J2EE or Web Services. Any combination of the EJB interface 302, Web Services interface 304, the HTTP interface 306, and/or any other desired interface may be used. In addition, new interfaces may be added to the client handler 206 as they are available and/or become needed or useful. For example, the client handler 206 may include a SOAP interface, a servlet interface, a JMS interface, etc.

The EJB interface 302, Web Services interface 304, and/or the HTTP interface 306 of the illustrated example receive message(s) from the clients, send messages to the clients, provide blocking functionality, and handle other aspects of communication with the clients. Message(s) received from the clients are transmitted to the authenticator 310. In the illustrated example, response(s) to message(s) that are destined for the EJB interface 302, the Web Services 304, and the HTTP interface 306 are authenticated by the authenticator 310 and sent to the interfaces. Alternatively, the authenticator 310 may only authenticate messages and may not authenticate responses. Therefore, the responses will be sent from the message handler interface 312 directly to the EJB interface 302, the Web Services 304, and/or the HTTP interface 306.

The authenticator 310 of the illustrated example checks message(s) received from the EJB interface 302, Web Services interface 304, and the HTTP interface 306 and response(s) received from the message handler interface 312 to ensure that they are authorized. The authenticator 310 may authenticate message(s) and/or response(s) by verifying usernames/passwords, checking certificates, checking security keys, verifying serial numbers associated with the message(s) and/or response(s), etc. In addition, the authenticator 310 may ensure that response(s) are routed to the appropriate client.

The message handler interface 312 of the illustrated example handles communication between the client handler 206 and a message handler. The message handler interface 312 may be implemented using any communication method or protocol. The message handler interface 312 of the illustrated example transmits message(s) to a connected message handler and receives response(s) from the connected message handler.

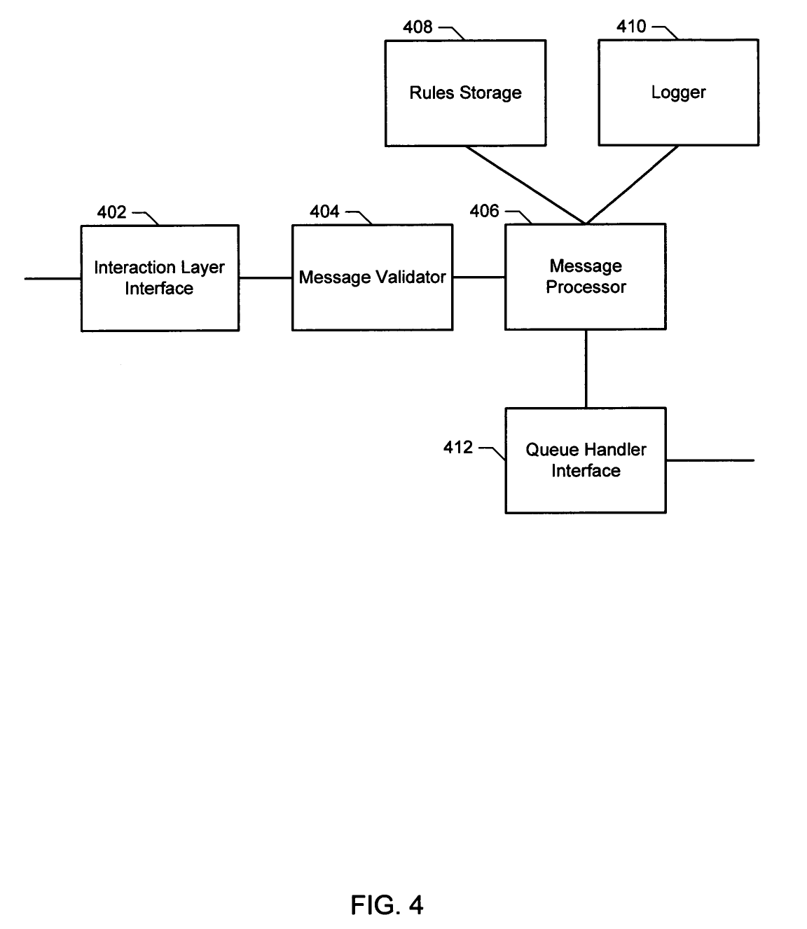

FIG. 4 is a block diagram of an example implementation of the message handler 208 of FIG. 2. The example message handler 208 of FIG. 4 includes an interaction layer interface 402, a message validator 404, a message processor 406, a rules storage 408, a logger 410, and a queue handler interface 412.

The interaction layer interface 402 of the illustrated example handles communication between the message handler 208 and a client handler. The interaction layer interface 402 may be implemented using any communication method or protocol. The interaction layer interface 402 of the illustrated example receives messages from a connected client handler and transmits responses to the connected client handler.

The message validator 404 of the illustrated example receives messages from the interaction layer interface 402 and verifies that they have the proper format and structure. If a received message is found to have an incorrect format or structure, the message validator 404 of the illustrated example notifies the message processor 406. For example, as previously described, if the message is in XML format but is not properly formatted, the message validator 404 will notify the message processor 406.

The message processor 406 of the illustrated example enforces the rules stored in the rules storage 408 and follows instructions received from the message validator 404 to ensure that messages will be understood by a CTI server. The message processor 406 may change the format of the message based on rules stored in the rules storage 408. For example, the message processor 406 may change the message format from HTML to XML, from XML to HTML, from plaintext to XML, from plaintext to HTML, etc. The message processor 406 may additionally change the content of the message. For example, if the message contains multiple requests, the message processor 406 may extract each of the requests and generate and transmit a new message for each of the requests. This process allows the clients to preserve bandwidth by bundling messages. Once messages have been converted, the message processor 406 transmits messages to the queue handler interface 412.

When the message processor 406 of the illustrated example receives responses from the queue handler interface 412, the message processor 406 converts the messages to the format associated with the client to which the response is destined. The conversion may be substantially similar to the conversions described in the previous paragraph in relation to messages.

The rules storage 408 of the illustrated example may be implemented by any storage device capable of storing rules for messages and responses. The rules storage 408 may include an external interface to enter rules and/or may receive rules from the message processor 406.

The logger 410 of the illustrated example is capable of logging the changes made to messages and responses by the message processor 406. The logger 410 of the illustrated example may additionally log any other event that occurs at the message handler 208 such as, for example, an error found in messages by the message validator 404, an error connecting to a queue handler returned by the queue handler interface 412, an error locating a rule in the rules storage 408, etc. The logger 410 of the illustrated example is capable of storing the log in a flat file located on the message handler 208, a database located external to the message handler 208, a java messaging interface logging solution, etc. The logger 410 of the illustrated example may be implemented using, for example, Jakarta Common Logging or Log4J by the Apache Software Foundation.

The queue handler interface 412 of the illustrated example handles communication between the message handler 208 and a queue handler. The queue handler interface 412 may be implemented using any communication method or protocol available. The queue handler interface 412 transmits messages to a connected queue handler and receives responses from the connected queue handler.

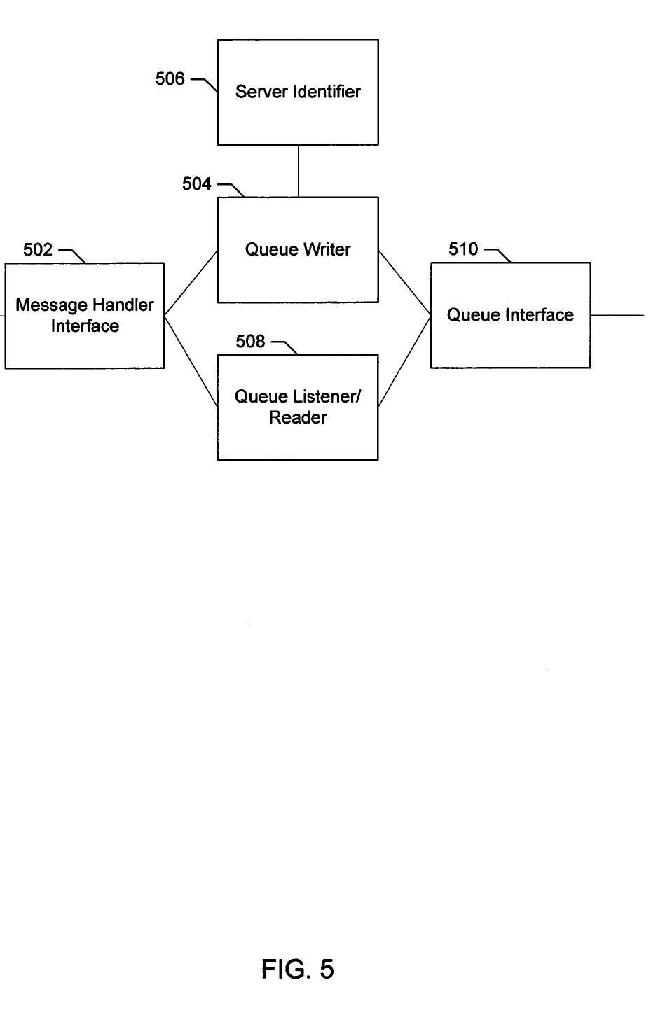

FIG. 5 is a block diagram of an example implementation of the queue handler 210 of FIG. 2. The example queue handler 210 of FIG. 5 includes a message handler interface 502, a queue writer 504, a server identifier 506, a queue listener/reader 508, and a queue interface 510.

The message handler interface 502 of the illustrated example handles communication between the queue handler 210 and a message handler. The message handler interface 502 may be implemented using any communication method or protocol. The message handler interface 502 of the illustrated example transmits messages to a connected queue handler and receives responses from the connected queue handler.

The server identifier 506 of the illustrated example receives part or all of a message to be written to a queue from the queue writer 504, and returns an identifier associated with a server associated with the message. For example, the server identifier 506 of the illustrated example may parse a message body to determine which server is to handle the message. The server identifier 506 of the illustrated example compares the destination to a list of identifiers to determine an identifier associated with the server. Alternatively, any other method of determining a server identifier may be used. In addition, the server identifier 506 of the illustrated example returns an identifier associated with the queue to which the message is to be written. The server identifier and/or the queue identifier are then transmitted to the queue writer 504.

The queue listener/reader 508 of the illustrated example retrieves responses from a queue via the queue interface 510. The queue listener/reader 508 of the illustrated example periodically polls the queue to determine when responses are available to be retrieved. Additionally or alternatively, the queue listener/reader 508 may receive broadcasts from the queue when responses are available to be retrieved. If multiple queues are present, the queue listener/reader 508 may monitor one of the queues, a subset of the queues, or all of the queues. The queue listener/reader 508 of the illustrated example sends responses retrieved from the queue or queues to the message handler interface 502.

The queue interface 510 of the illustrated example handles communication between the queue handler 210 and a queue. The queue interface 510 may be implemented using any communication method or protocol. The queue interface 510 of the illustrated example transmits messages to a connected queue and retrieves responses from a connected queue. The queue interface 510 may not be used if the queue is a part of the queue handler 210.

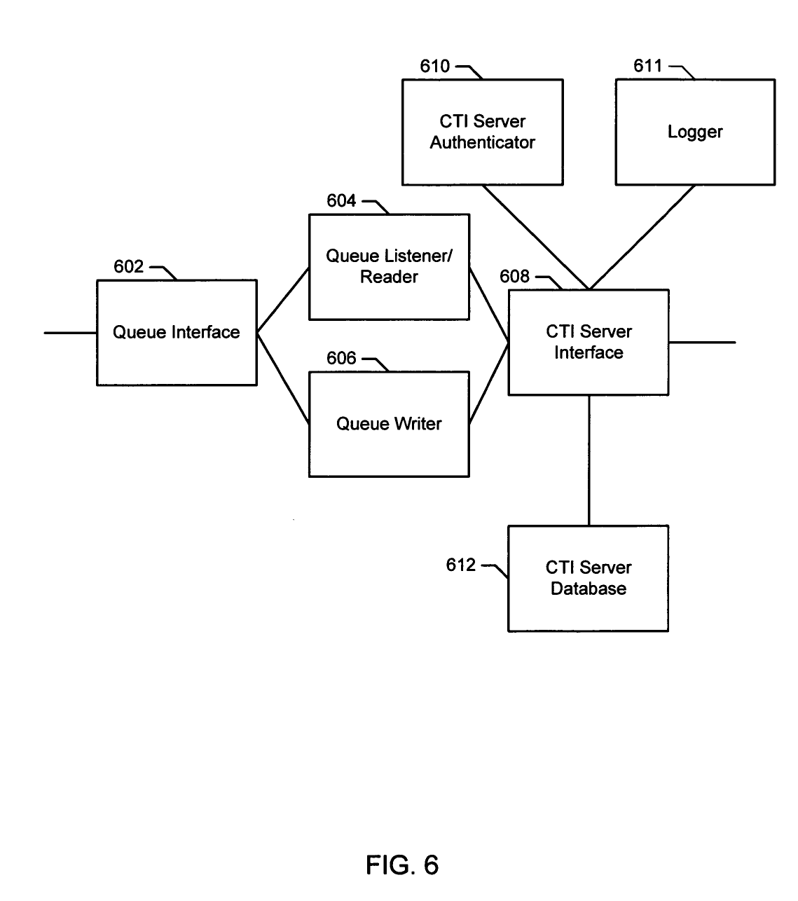

FIG. 6 is a block diagram of an example implementation of the CTI driver 218 of FIG. 2. The example CTI driver 218 of FIG. 6 includes a queue interface 602, a queue listener/reader 604, a queue writer 606, a CTI server interface 608, a CTI server authenticator 610, and a CTI server database 612.

The queue interface 602 handles communication between the CTI driver 218 and a queue. The queue interface 602 may be implemented using any communication method or protocol. The queue interface 602 of the illustrated example transmits messages to a connected queue and retrieves responses from a connected queue. The queue interface 602 may not be used if the queue is a part of the CTI driver 218.

The queue listener/reader 604 of the illustrated example retrieves messages from a queue via the queue interface 602. The queue listener/reader 604 of the illustrated example periodically polls the queue to determine when messages are available to be retrieved. Additionally or alternatively, the queue listener/reader 604 may receive broadcasts from the queue when messages are available to be retrieved. If multiple queues are present, the queue listener/reader 604 may monitor one of the queues, a subset of the queues, or all of the queues. The queue listener/reader 604 of the illustrated example sends responses retrieved from the queue or queues to the CTI server interface 608.

The queue writer 606 of the illustrated example receives responses from the CTI server interface 608 and writes the responses to a queue via the queue interface 602. The queue writer 606 of the illustrated example additionally writes any other parameters that are received with the response to the queue. For example, the queue writer 606 may receive a CallID and may generate a CorrelationID based on that CallID. The CorrelationID may be written to the queue in order to identify the response and the source message associated with that response.

The CTI server interface 608 of the illustrated example handles communication between CTI driver 218 and a CTI server. The CTI server interface 608 may be implemented using any communication method or protocol. The CTI server interface 608 of the illustrated example transmits messages to a connected CTI server and retrieves responses from a connected CTI server. If multiple CTI servers are present, the CTI server interface 608 may determine which CTI server to write to based on the content of the message or parameters associated with the message. The CTI server interface 608 may retrieve information from the CTI server database 612 to determine how to connect to the CTI server.

The CTI server authenticator 610 of the illustrated example authenticates the CTI driver 218 with a connected CTI server. The CTI server authenticator 610 may use any method of authenticating the CTI driver 218 with a CTI server. For example, the CTI server authenticator 610 may send a username and password to the CTI server, may exchange security certificates with the CTI server, etc. The CTI server authenticator 610 may not be necessary if, for example, no authentication with a CTI server is necessary.

The logger 611 of the illustrated example is capable of logging the actions of the CTI driver 218. For example, the logger 611 may log when messages are retrieved from a queue, when responses are written to a queue, the content of messages sent to the CTI server 102, the content of responses received from the CTI server 102, etc. The logger 611 of the illustrated example is capable of storing the log in a flat file located on the CTI driver 218, a database located external to the CTI driver 218, a java messaging interface logging solution, etc. The logger 611 may be implemented using, for example, Jakarta Common Logging or Log4J by the Apache Software Foundation.

The CTI server database 612 of the illustrated example stores information about available CTI servers. The CTI server database 612 may include information about how to connect to CTI servers, may include information about which CTI servers can handle which messages, etc. The CTI server database 612 may be any kind of database, file, or other storage capable of storing information about available CTI servers 612. The CTI server database 612 may not be necessary when the CTI driver 218 is only connected to a single CTI server.

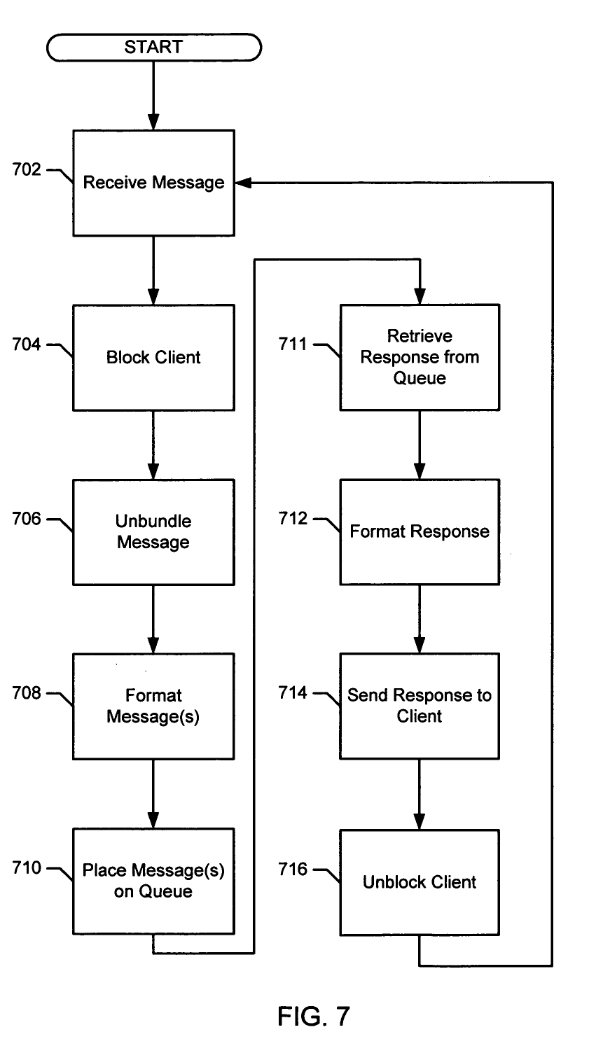

FIG. 7 is a flow diagram representative of machine readable instructions that may be executed to implement the example client handler 206, message handler 208, and queue handler 210 of FIG. 2 and/or the components described in connection with FIGS. 3, 4, 5, and/or 6. Execution begins when one of the EJB interface 302, the Web Services interface 304, or the HTTP interface 306 of the client handler 206 receives a message from a client and sends the message to the message handler 208 (block 702). The client handler 206 receiving interface blocks the client, which causes the client to wait for the corresponding interface of the client handler 206 to return a response. Then, if the message contains multiple requests for a CTI server, the message processor 406 of the message handler 208 unbundles the multiple requests and generates separate messages for each of the requests (block 706). Then, the message processor 406 of the message handler 208 formats the message (or messages if multiple messages have been unbundled) to be compatible with the CTI server (block 708). Then, the queue writer 504 of the queue handler 210 places the message or messages on an available queue (block 710). Next, if there is a response waiting in the queue, the queue listener/reader 508 of the queue handler 210 retrieves the response from the queue (block 711). The message processor 406 of the message handler 208 receives the response from the queue handler and formats the message to be compatible with the client to which the response is directed (block 712). Then the message handler interface 312 of the client handler 206 receives the response from the message handler 208 and the interface of the client handler 206 that is associated with the client sends the response to the client (block 714). The interface of the client handler 206 associated with the client then unblocks the client (block 716). Control then returns to block 702.

While the flowchart of FIG. 7 includes a single control path, persons of ordinary skill in the art will recognize that the execution may proceed in other manners. For example, the check for responses on the queue does not need to occur after one or more messages have been placed on the queue. Rather, the queue listener/reader 508 of the queue handler 210 may periodically check the queue to determine when responses are available. In addition, the queue writer 504 of the queue handler 210 may place several messages received from multiple clients on the queue before a response to the first message is placed on the queue. In other words, messages are placed on the queue as they are received and responses are retrieved from the queue and processed as they are ready. Thus, blocks 702 to 710 may operate independently of or simultaneously with blocks 711 to 716 and/or multiple instances of any of the blocks of FIG. 7 may operate in parallel.

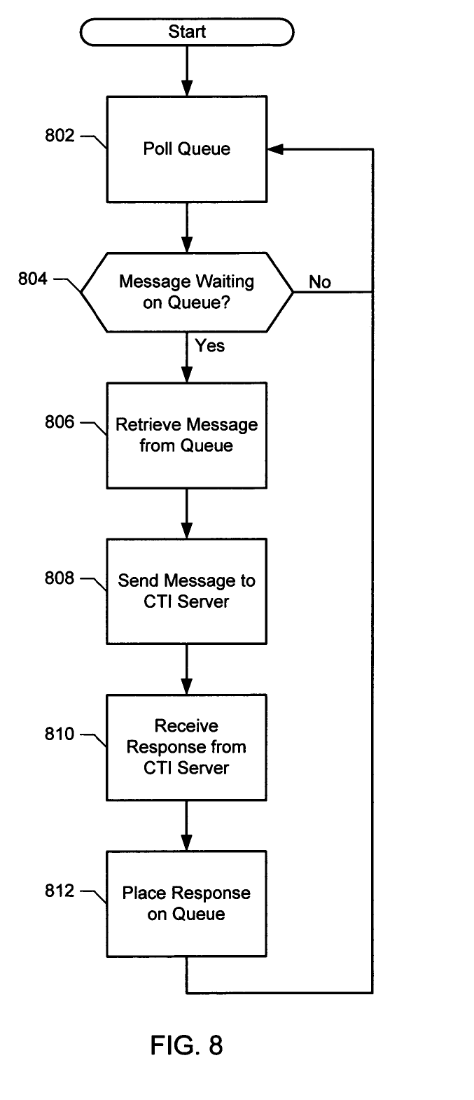

FIG. 8 is a flow diagram representative of machine readable instructions that may be executed to implement the example CTI driver 218 of FIG. 2. Execution begins by polling the queue to determine if any messages are waiting on the queue (block 802 and 804). For example, the queue listener/reader 604 of FIG. 6 may request the status of the queue. If no messages are waiting on the queue, control returns to block 802 and the CTI driver 218 continues polling the queue. If a message is waiting on the queue, the CTI driver 218 retrieves the message from the queue (block 806). The CTI driver 218 then sends the message to a connected CTI server (block 808). The CTI driver 218 then receives a response from the CTI server (block 810). The CTI driver 218 then places the response on the queue (block 812). For example, the queue writer 606 of FIG. 6 may receive the message and write it to a queue. Then, control returns to block 802 to continue polling the queue.

While the flowchart of FIG. 8 includes a single flow, persons of ordinary skill in the art will recognize that the execution may proceed in other manners. For example, receiving responses from the CTI server (block 810) may occur independently and/or simultaneously with sending messages to the CTI server (block 806 and 808) and/or multiple instances of any of the blocks of FIG. 8 may operate in parallel. In other words, the CTI driver 218 may concurrently send messages to the CTI server and retrieve responses from the CTI server.

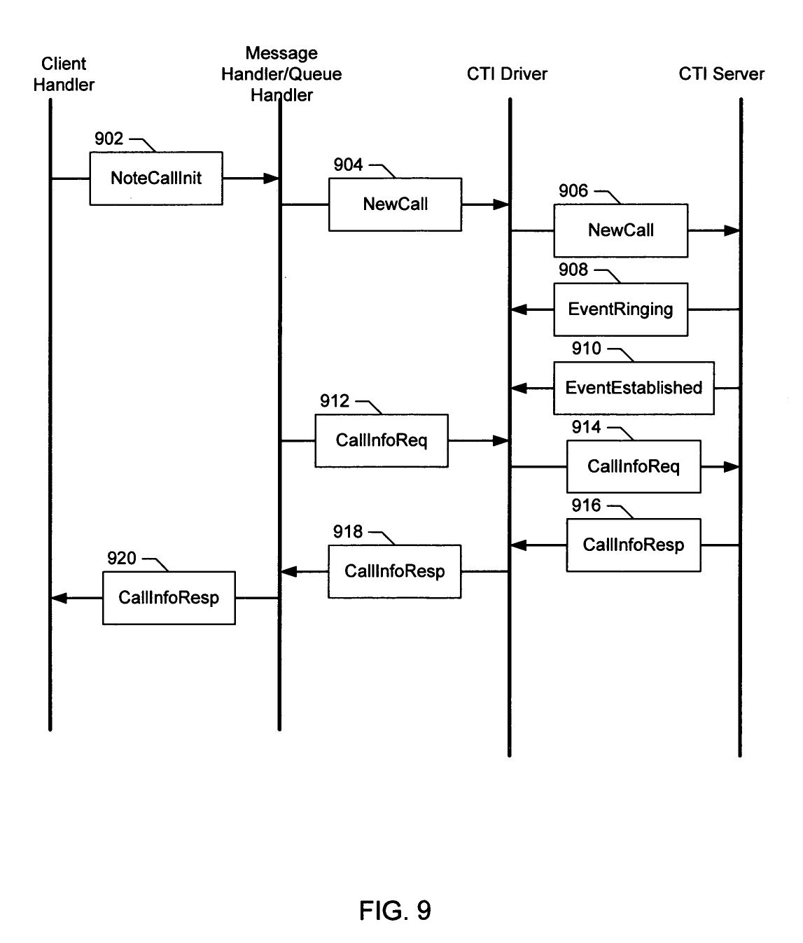

FIGS. 9-14 are flow diagrams illustrating how several example requests from clients may be handled by the example system of FIG. 2, including the client handler 206, the message handler 208, the queue handler 210, the CTI driver 218, and the CTI server 102. While the diagrams of FIGS. 9-14 illustrate a substantially continuous flow, persons of ordinary skill in the art will recognize that the flow may not be continuous. In particular, other messages and responses may be processed between a message being delivered to a queue by the queue handler 210 and a response to that message being transmitted by the CTI server 102. For example, if messages are already waiting on the queue, the next message placed on the queue will have to wait until the messages waiting before the next message are processed. In the meantime, several responses may be transmitted by the CTI server 102.

FIG. 9 is a flow diagram illustrating how an example request to initialize a new call may be handled by the example system of FIG. 2. The flow diagram of FIG. 9 begins when the client handler 206 receives a message to start a new call (NewCall) and return call information (CallInfoReq) (the NewCall and the CallInfoReq are combined to form a single NoteCallInit message) from a client (block 902). The message handler 208 separates the two messages and, then, formats and sends the NewCall message to the queue via the queue handler 210 (block 904). Subsequently, the CTI driver 218 sees the NewCall message on the queue and sends the message to the CTI server 102 (block 906). The CTI server 102 then responds with a response to indicate that the CTI server 102 is dialing (EventDialing) and later response to indicate that the call has been established (EventEstablished) (block 908 and 910).

Next, the message handler 208 formats and sends the second part of the NoteCallInit message, (i.e., CallInfoReq), to the queue via the queue handler 210 (block 912). The CTI driver 218 may cause the message handler 208 to wait for an indication to send the second message. The CTI driver 218 may indicate that the message handler 208 should send the second message after receiving a response to the first message from the CTI server 102. After receiving the CallInfoReq message, the CTI driver 218 sends the CallInfoReq message to the CTI server 102 (block 914). The CTI server 102 returns the call information response (CallInfoResp) to the CTI driver 218 (block 916). The CTI driver 218 sends the CallInfoResp to the queue and the queue handler 210 retrieves the response and sends it to the message handler 208 (block 918). The message handler 208 formats the message and sends it to the client handler 206 (block 920). The client handler 206 then returns the CallInfoReq to the client that sent the NoteCallInit message.

The following XML code is an example of the NoteCallInit message. The first two lines indicate the message formatting and structure. The third line indicates the start of the message. The fourth line indicates the CallID identifier associated with the call that is associated with the message. The fifth line indicates the TMS number associated with the destination server. The sixth line indicates the port of the CTI server 102 that should be used to send the message. The seventh line indicates the request (NotCallInit) that is associated with the message. The eighth line indicates end of the message.

| | |
|---|---|
| 1 | <?xml version=\‘1.0\’ encoding=\‘iso-8859-1\’?> |
| 2 | <DOCTYPE GctiMsg SYSTEM \‘/appl/genesys/IServer.dtd’>” |
| 3 | <GctiMsg> |

| | |
|---|---|
| 4 | <CallId> sida5011022034576a3f9cd456</CallId>” |
| 5 | <TMS>1051<./TMS> |
| 6 | <IVRPORT>001</IVRPORT> |
| 7 | <NoteCallInit CallControlMode=\‘Network\’/> |

| | |
|---|---|
| 8 | </GctiMsg> |

The following XML code is an example NewCall message. The first four lines are similar to the first four lines of NoteCallInit described above. The fifth line indicates that the message is a NewCall message. The sixth line indicates the port of the CTI server 102 that should be used to send the message. The seventh line indicates the end of the NewCall message. The eighth line indicates the end of the entire message.

| | |
|---|---|
| 1 | <?xml version=\′1.0\′ encoding=\′iso-8859-1\′?> |
| 2 | <DOCTYPE GctiMsg SYSTEM \′Server.dtd\′> |
| 3 | <GctiMsg> |

| | |
|---|---|
| 4 | <CallId> sida5011022034576a3f9cd456</CallId> |
| 5 | <NewCall CallControlMode=′Network′ Version=’2.0’> |

| | |
|---|---|
| 6 | <CalledNum>001</CalledNum> |

| | |
|---|---|
| 7 | </NewCall> |

| | |
|---|---|
| 8 | </GctiMsg> |

The following XML code is an example EventDialing message. The first four lines are similar to the first four lines of NoteCallInit described above. The fifth line indicates that the message is an EventDialing message. The sixth line indicates the end of the EventDialing message.

| | |
|---|---|
| 1 | <?xml version=′1.0′ encoding=′iso-8859-1′?> |
| 2 | <!DOCTYPE GctiMsg SYSTEM ′IServer.dtd′> |
| 3 | <GctiMsg> |

| | |
|---|---|
| 4 | <CallId> sida5011022034576a3f9cd456</CallId> |
| 5 | <CallStatus Event=’Dialing’/> |

| | |
|---|---|
| 6 | </GctiMsg> |

The following XML code is an example EventEstablished message. The first four line lines are similar to the first four lines of NoteCallInit described above. The fifth line indicates that the message is an EventEstablished message. The sixth line indicates the end of the EventEstablished message.

| | |
|---|---|
| 1 | <?xml version=′1.0′ encoding=′iso-8859-1′?> |
| 2 | <!DOCTYPE GctiMsg SYSTEM ′IServer.dtd′> |
| 3 | <GctiMsg> |

| | |
|---|---|
| 4 | <CallId>sida5011022034576a3f9cd456</CallId> |
| 5 | <CallStatus Event=’Established’/> |

| | |
|---|---|
| 6 | </GctiMsg> |

The following XML code is an example CallInfoReq message. The first four lines are similar to the first four lines of NoteCallInit described above. The fifth line indicates that the message is a CallInfoReq message. The sixth line indicates the end of the CallInfoReq message.

| | |
|---|---|
| 1 | <?xml version=‘1.0’ encoding=‘iso-8859-1’?> |
| 2 | <!DOCTYPE GctiMsg SYSTEM ‘IServer.dtd’> |
| 3 | <GctiMsg> |

| | |
|---|---|
| 4 | <CallId>sida5011022034576a3f9cd456</CallId> |
| 5 | <CallInfoReq/> |

| | |
|---|---|
| 6 | </GctiMsg> |

The following XML code is an example CallIifoResp response that is sent from the CTI server 102 in response to the CallInfoReq message. The first four lines are similar to the first four lines of NoteCallInit described above. The fifth line indicates the dialed number identification service (DNIS) and automatic number identification (ANI) numbers associated with the call. The sixth line indicates the end of the CallInfoResp message.

| | |
|---|---|
| 1 | <?xml version=′1.0′ encoding=′iso-8859-1′?> |
| 2 | <!DOCTYPE GctiMsg SYSTEM ′IServer.dtd′> |
| 3 | <GctiMsg> |

| | |
|---|---|
| 4 | <CallId>sida5011022034576a3f9cd456</CallId> |
| 5 | <CallInfoResp DNIS=’1235551111’ ANI=’1235552222’/> |

| | |
|---|---|
| 6 | </GctiMsg> |

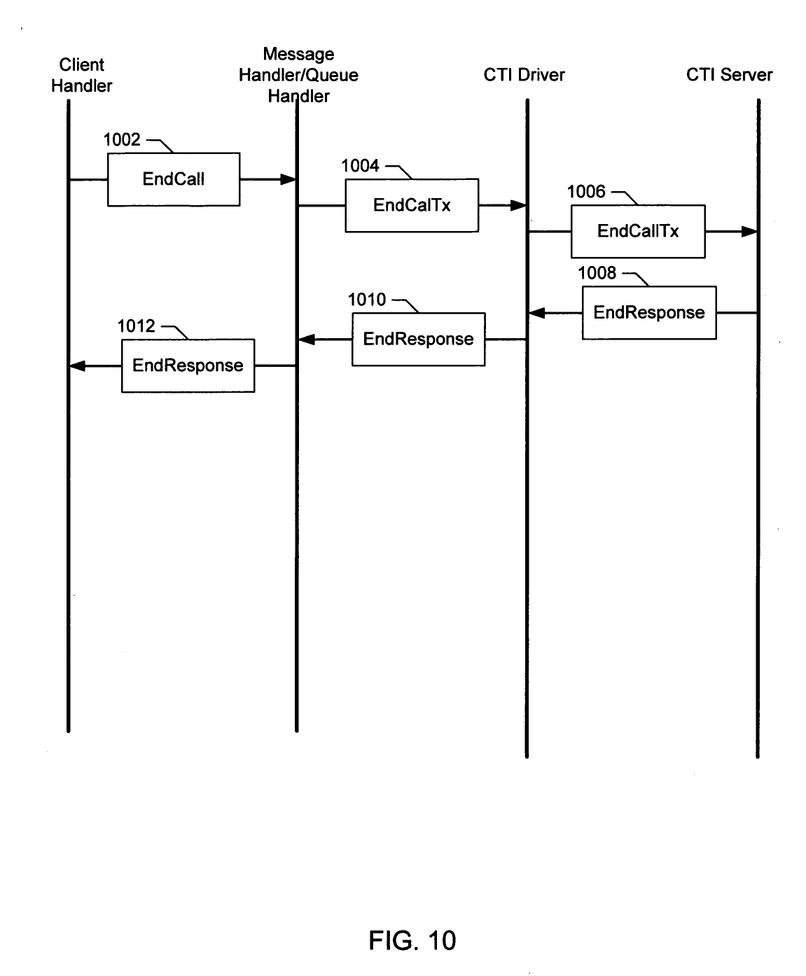

FIG. 10 is a flow diagram illustrating how a request to end a call (EndCall) may be handled by the example system of FIG. 2. The flow diagram of FIG. 10 begins when the client handler 206 receives an EndCall message from a client. The client handler 206 sends the EndCall message to the message handler 208 (block 1002). The message handler 208 translates the message an end call transaction message (EndCallTx) that is understood by the CTI server 102, and sends it to a queue via the queue handler 210 (block 1004). The CTI driver 218 retrieves the EndCallTx message from the queue and sends it to the CTI server 102 (block 1006). The CTI server 102 eventually responds with a message confirming the reception of the EndCallTx message (EndResponse) to the CTI driver 218, which places the response on the queue (block 1008). The queue handler 210 retrieves the response from the queue and sends the response to the message handler 208 (block 1010). The message handler 208 formats the response and sends the response to the client handler 206 (block 1012). The client handler 206 then sends the response to the client.

The following XML code is an example EndCall message. The first six lines are similar to the first six lines of NoteCallInit described above. The seventh line indicates that the message is an EndCall request. The eighth line indicates the end of the EndCall message.

| | |
|---|---|
| 1 | <?xml version=\‘1.0\’ encoding=\‘iso-8859-1\’?> |
| 2 | <!DOCTYPE GctiMsg SYSTEM \‘/appl/genesys/IServer.dtd\’> |
| 3 | <GctiMsg> |

| | |
|---|---|
| 4 | <CallId> sida5011022034576a3f9cd456</CallId> |
| 5 | <TMS>1051</TMS> |
| 6 | <IVRPORT>001</IVRPORT> |
| 7 | <EndCall EndCause=\‘Normal\’/> |

| | |
|---|---|
| 8 | </GctiMsg> |

The following XML code is an example EndCallTx message. The first four lines are similar to the first four lines of EndCall described above. The fifth line indicates that the message is an EndCall request. The eighth line indicates the end of the EndCall message. In other words, the EndCallTx message is similar to the EndCall message, but the TMS number and the IVRPORT tags removed.

| | |
|---|---|
| 1 | <?xml version=\‘1.0\’ encoding=\‘iso-8859-1\’?> |
| 2 | <!DOCTYPE GctiMsg SYSTEM \‘/appl/genesys/IServer.dtd\’> |
| 3 | <GctiMsg> |

| | |
|---|---|
| 4 | <CallId> sida5011022034576a3f9cd456</CallId> |
| 5 | <EndCall EndCause=\‘Normal\’/> |

| | |
|---|---|
| 6 | </GctiMsg> |

The following XML code is an example EndResponse message. The first three lines are similar to the first three lines of NoteCallInit described above. The fourth line indicates the CallID identifier associated with the call that was ended. The fifth line indicates that the EndCallTx was successful. The sixth line indicates the end of the EndResponse message.

| | |
|---|---|
| 1 | <?xml version=‘1.0’ encoding=‘iso-8859-1’?> |
| 2 | <!DOCTYPE GctiMsg SYSTEM ‘IServer.dtd’> |
| 3 | <GctiMsg> |

| | |
|---|---|
| 4 | <CallId>41</CallId> |
| 5 | <EndResponse Status=“Success”/> |

| | |
|---|---|
| 6 | </GctiMsg> |

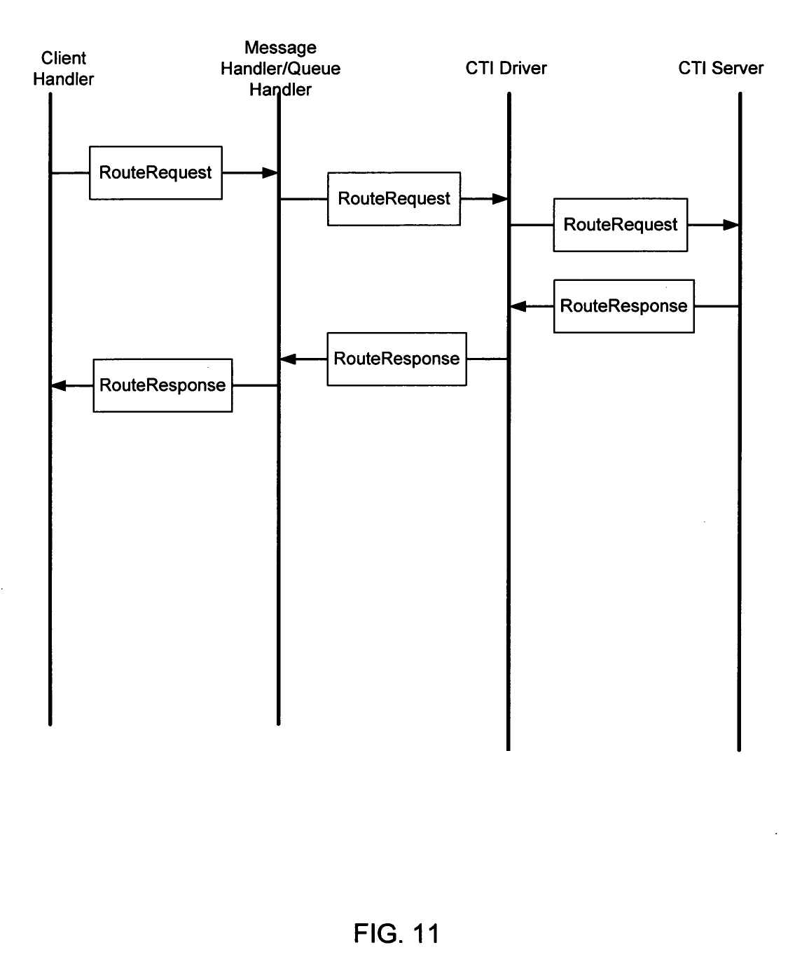

FIG. 11 is a flow diagram illustrating how a request to obtain a call routing number (RouteRequest) may be handled by the example system of FIG. 2. The flow diagram of FIG. 11 begins when the client handler 206 receives a RouteRequest message from a client. The client handler 206 sends the RouteRequest message to the message handler 208 (block 1102). The message handler 208 formats the message and sends it to a queue via the queue handler 210 (block 1104). The CTI driver 218 retrieves the RouteRequest message from the queue and sends it to the CTI server 102 (block 1106). The CTI server 102 eventually responds by sending a message indicating the call routing number to be used to route the call (RouteResponse) to the CTI driver 218, which places the response on the queue (block 1108). The queue handler 210 retrieves the response from the queue and sends the response to the message handler 208 (block 1110). The message handler 208 formats the response and sends the response to the client handler 206 (block 1112). The client handler 206 then sends the response to the client.

The following XML code is an example RouteRequest message. The first five lines are similar to the first five lines of NoteCallInit described above. The sixth line indicates the start of the RouteRequest message body. The seventh line indicates the start of an UData set associated with the message. The RouteDN value indicates the route point value that the CTI server 102 may use to determine whether to add the attached data to a call package or the replace the data in the call package with the attached data. The seventh line indicates the start of the data that is associated with the RouteRequest. The eighth line indicates the data that is attached to the RouteRequest. The ninth line indicates the end of the data associated with the RouteRequest. The tenth line indicates the end of the RouteRequest message. The eleventh line indicates the end of the entire message.

| | |
|---|---|
| 1 | <?xml version=′1.0′ encoding=“iso-8859-1”?> |
| 2 | <DOCTYPE GctiMsg SYSTEM “/appl/genesys/IServer.dtd”> |
| 3 | <GctiMsg> |

| | |
|---|---|
| 4 | <CallId> sida5011022034576a3f9cd456</CallId> |
| 5 | <TMS>001</TMS> |
| 6 | <RouteRequest RouteDN=’routepoint’> |

| | |
|---|---|
| 7 | <UDataEx> |

| | |
|---|---|
| 8 | <Node Name=′tagname1′ Type=′Int′ Val=′tagval1′/> |

| | |
|---|---|
| 9 | </UDataEx> |

| | |
|---|---|
| 10 | </RouteRequest> |

| | |
|---|---|
| 11 | </GctiMsg> |

The following XML code is an example RouteResponse response. The first four lines are similar to the first five lines of NoteCallInit described above. The fifth line indicates that the message is a RouteResponse response. The sixth line indicates the call routing number that is returned by the CTI server 102. The seventh line indicates the start of an UData set associated with the response. The eighth line indicates that the transfer is a CTI transfer. The ninth line indicates that the destination program is a PERI program. The tenth line indicates the end of the UData set. The eleventh line indicates the end of the RouteResponse. The twelfth line indicates the end of the entire response.

| | |
|---|---|
| 1 | <?xml version=′1.0′ encoding=′iso-8859-1′?> |
| 2 | <!DOCTYPE GctiMsg SYSTEM ′/appl/genesys/IServer.dtd′> |
| 3 | <GctiMsg> |

| | |
|---|---|
| 4 | <CallId>sida5011022034576a3f9cd456</CallId> |
| 5 | <RouteResponseRouteType=′Default′> |

| | |
|---|---|
| 6 | <Dest>9123555333355</Dest> |
| 7 | <UDataEx> |

| 8 | <Node Name=′TRANSFER_TYPE′ Type=′Str′ |
|---|---|
| | Val=′CTI′/> |
| 9 | <Node Name=′DEST_PROGRAM_NAME′ |
| | Type=′Str′ |

Val=’PeriProPgmName’/>

| | |
|---|---|
| 10 | </UDataEx> |

| | |
|---|---|
| 11 | </RouteResponse> |

| | |
|---|---|
| 12 | </GctiMsg> |

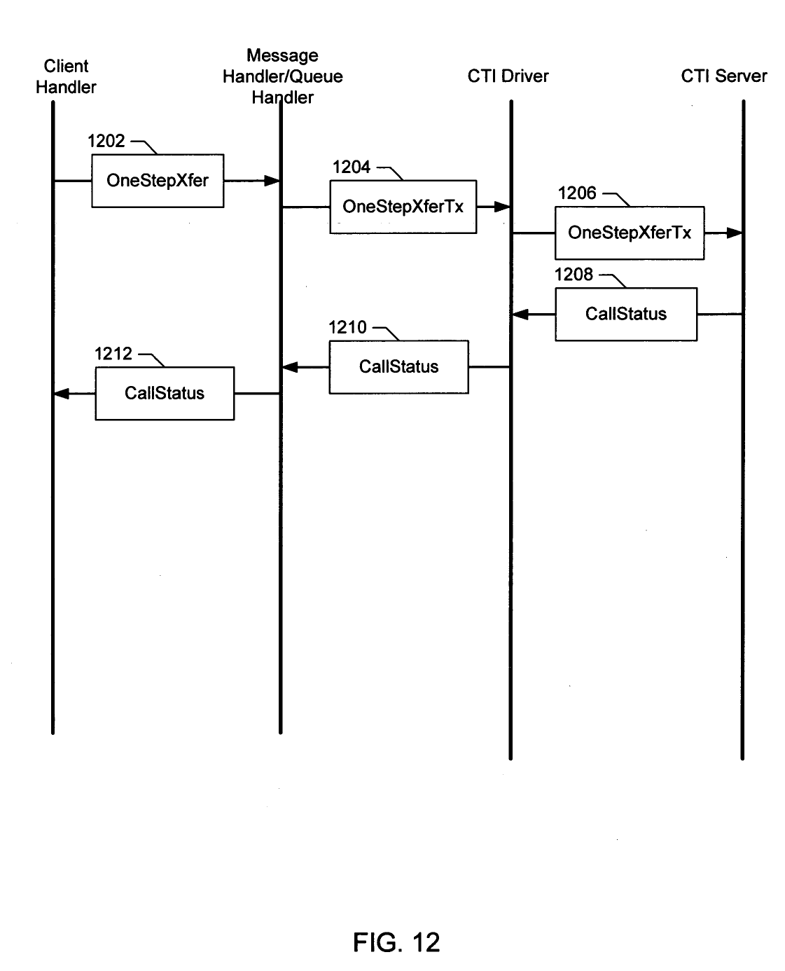

FIG. 12 is a flow diagram illustrating how a request to transfer a call to another CTI system (OneStepXfer) may be handled by the example system of FIG. 2. The flow diagram of FIG. 12 begins when the client handler 206 receives an OneStepXfer message from a client. The client handler 206 sends the OneStepXfer message to the message handler 208 (block 1202). The message handler 208 translates the message to a call transfer transaction message by removing the TMS number (OneStepXferTx) and sends it to a queue via the queue handler 210 (block 1204). The CTI driver 218 retrieves the OneStepXferTx message from the queue and sends it to the CTI server 102 (block 1206). The CTI server 102 eventually responds and sends a response indicating that the status of the call (CallStatus) to the CTI driver 218, which places the response on the queue (block 1208). The queue handler 210 retrieves the response from the queue and sends the response to the message handler 208 (block 1210). The message handler 208 formats the response and sends the response to the client handler 206 (block 1212). The client handler 206 then sends the response to the client.

The following XML code is an example OneStepXfer message. The first four lines are similar to the first four lines of NoteCallInit described above. The sixth line indicates the start of the OneStepXfer request and indicates the number to which the call is to be transferred. The seventh line indicates the end of the OneStepXfer request. The eighth line indicates the end of the OneStepXfer message.

| | |
|---|---|
| 1 | <?xml version=“1.0” encoding=“iso-8859-1”?> |
| 2 | <!DOCTYPE GctiMsg SYSTEM “IServer.dtd”> |
| 3 | <GctiMsg> |

| | |
|---|---|
| 4 | <CallId>sida5011022034576a3f9cd456</CallId> |
| 5 | <TMS>0001</TMS> |
| 6 | <OneStepXfer DestDN=“9123555333355”> |
| 7 | </OneStepXfer> |

| | |
|---|---|
| 8 | </GctiMsg> |

The following XML code is an example OneStepXferTx message. The first four lines are similar to the first four lines of OneStepXfer described above. The fifth through seventh lines are similar to the sixth through eighth lines of OneStepXfer described above. In other words, the OneStepXferTx message is similar to the OneStepXfer message, but the TMS number is removed.

| | |
|---|---|
| 1 | <?xml version=“1.0” encoding=“iso-8859-1”?> |
| 2 | <!DOCTYPE GctiMsg SYSTEM “IServer.dtd”> |
| 3 | <GctiMsg> |

| | |
|---|---|
| 4 | <CallId>sida5011022034576a3f9cd456</CallId> |
| 5 | <OneStepXfer DestDN=“9123555333355”> |
| 6 | </OneStepXfer> |

| | |
|---|---|
| 7 | </GctiMsg> |

The following XML code is an example CallStatus response. The first four lines are similar to the first four lines of NoteCallInit described above. The fifth line indicates whether the One StepXfer request was successful. The sixth line indicates the end of the CallStatus message.

| | |
|---|---|
| 1 | <?xml version=‘1.0’ encoding=‘iso-8859-1’?> |
| 2 | <!DOCTYPE GctiMsg SYSTEM ‘/appygenesys/IServer.dtd’> |
| 3 | <GctiMsg> |

| | |
|---|---|
| 4 | <CallId>sida5011022034576a3f9cd456</CallId> |
| 5 | <CallStatus Event=‘XferComplete’/> |

| | |
|---|---|
| 6 | </GctiMsg> |

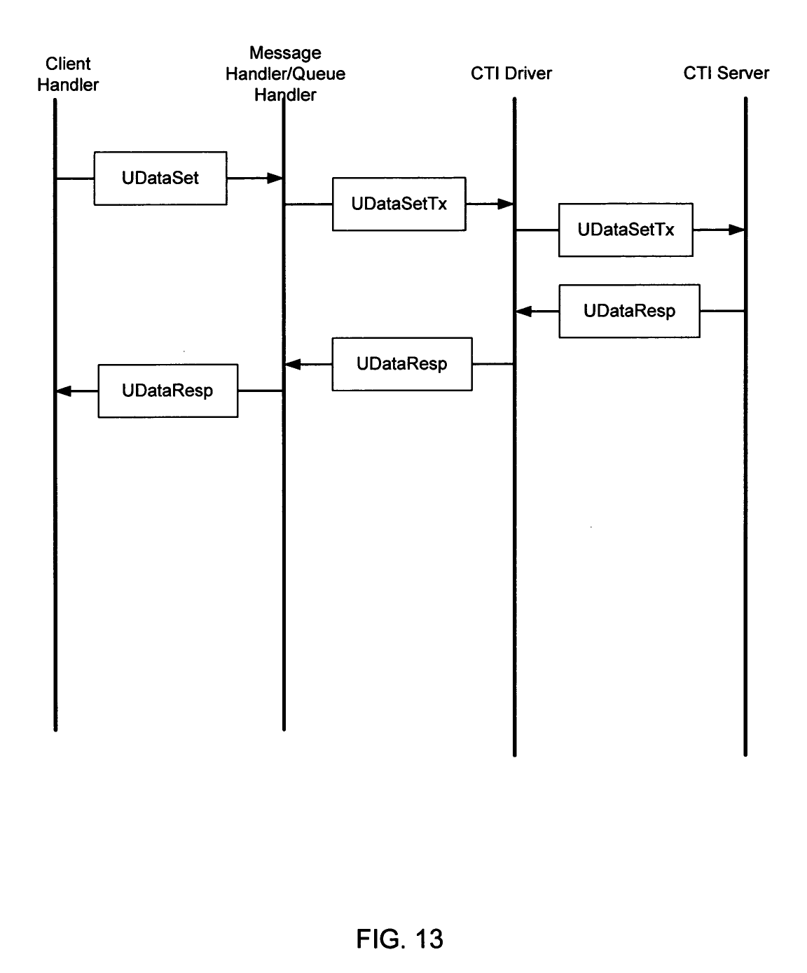

FIG. 13 is a flow diagram illustrating how a message to attach data to a call (UDataSet) may be handled by the example system of FIG. 2. The flow diagram of FIG. 13 begins when the client handler 206 receives a UDataSet message from a client. The client handler 206 sends the UDataSet message to the message handler 208 (block 1302). The message handler 208 translates the message to a UDataSetTx message by removing the TMS number and sends it to a queue via the queue handler 210 (block 1304). The CTI driver 218 retrieves the UDataSetTx message from the queue and sends it to the CTI server 102 (block 1306). The CTI server 102 eventually responds and by sending a message indicating whether the data was properly received (UDataResp) to the CTI driver 218, which places the response on the queue (block 1308). The CTI server 102 may indicate that the data was received successfully (Success), that the data was for a call that does not exist (NoSuchCall), that the data does not match the call (NoMatch), that the feature is not supported by the CTI server 102 (FeatureNotSupported), or that a miscellaneous error occurred (MiscError). The queue handler 210 retrieves the response from the queue and sends the response to the message handler 208 (block 1310). The message handler 208 formats the response and sends the response to the client handler 206 (block 1312). The client handler 206 then sends the response to the client.

The following XML code is an example UDataSet message. The first five lines are similar to the first five lines of NoteCallInit described above. The sixth line indicates the start of a UDataSet that is to replace data associated with the call. If the UDataSet was intended to add to the data associated with a call, the action would be \′ Add\′. The seventh line indicates the identifier associated with the UDataSet request. This number uniquely identifies the request. The eighth line identities the start of the data to be associated with the call. Lines nine through twelve are the data that is to be associated with the call. Line twelve illustrates that as many nodes as desired may be included. The thirteenth line indicates the end of the data. The fourteenth line indicates the end of the UDataSet. The fifteenth line indicates the end of the message.

| | |
|---|---|
| 1 | <?xml version=\′1.0\′ encoding=\′iso-8859-1\′?> |
| 2 | <!DOCTYPE GctiMsg SYSTEM \′/appl/genesys/IServer.dtd\′> |
| 3 | <GctiMsg> |

| | |
|---|---|
| 4 | <CallId>sida5011022034576a3f9cd456</CallId> |
| 5 | <TMS>0001</TMS> |
| 6 | <UDataSet Action=\′RepIace\′> |

| | |
|---|---|
| 7 | <RequestId>3252</RequestId> |
| 8 | <UDataEx> |

| | |
|---|---|
| 9 | <Node Name=′tagname1′ Type=′Str′ Val=′tagval1′/> |
| 10 | <Node Name=′tagname2′ Type=′Str’ Val=′tagval2′/> |
| 11 | <Node Name=′tagname3′ Type=′Str′ Val=’tagval3′/> |
| 12 | .......(as many nodes as you need) |

| | |
|---|---|
| 13 | </UDataEx> |

| | |
|---|---|
| 14 | </UDataSet> |

| | |
|---|---|
| 15 | </GctiMsg> |

The following XML code is an example UDataSetTx message. The first four lines are similar to the first four lines of UDataSet described above. The fifth through fourteenth lines are similar to the sixth through fifteenth lines of UDataSet described above. In other words, the UDataSetTx message is similar to the UDataSet message, but the TMS number has been removed.

| | |
|---|---|
| 1 | <?xml version=\′1.0\′ encoding=\′iso-8859-1\′?> |
| 2 | <!DOCTYPE GctiMsg SYSTEM \′/appl/genesys/IServer.dtd\′> |
| 3 | <GctiMsg> |

| | |
|---|---|
| 4 | <CallId>sida5011022034576a3f9cd456</CallId> |
| 5 | <UDataSet Action=\′Replace\′> |

| | |
|---|---|
| 6 | <RequestId>requestID</RequestId> |
| 7 | <UDataEx> |

| | |
|---|---|
| 8 | <Node Name=′tagname1′ Type=′Str′ Val=′tagval1′/> |
| 9 | <Node Name=′tagname2′ Type=′Str’ Val=′tagval2′/> |
| 10 | <Node Name=′tagname3′ Type=′Str′ Val=’tagval3′/> |
| 11 | .......(as many nodes as you need) |

| | |
|---|---|
| 12 | </UDataEx> |

| | |
|---|---|
| 13 | </UDataSet> |

| | |
|---|---|
| 14 | </GctiMsg> |

The following XML code is an example UDataResp message. The first four lines are similar to the first four lines of NoteCallInit described above. The fifth line indicates that the UDataSet was successful. The sixth line indicates the end of the UDataResp message.

| | |
|---|---|
| 1 | <?xml version=′1.0′ encoding=′iso-8859-1′?> |
| 2 | <!DOCTYPE GctiMsg SYSTEM ′IServer.dtd′> |
| 3 | <GctiMsg> |

| | |
|---|---|
| 4 | <CallId>41</CallId> |
| 5 | <UDataResp Result=’Success’/> |

| | |
|---|---|
| 6 | </GctiMsg> |

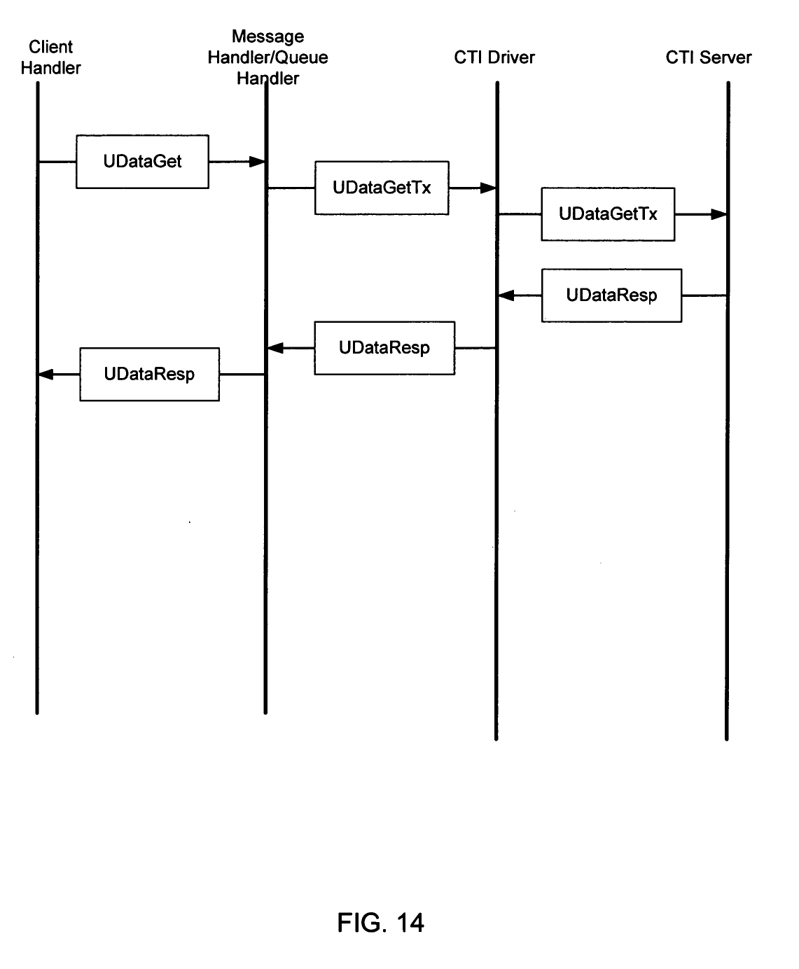

FIG. 14 is a flow diagram illustrating how a message to data associated with a call (UDataGet) may be handled by the example system of FIG. 2. The flow diagram of FIG. 14 begins when the client handler 206 receives a UDataGet message from a client. The client handler 206 sends the UDataGet message to the message handler 208 (block 1402). The message handler 208 formats the message and sends it to a queue via the queue handler 210 (block 1404). The CTI driver 218 retrieves the UDataGet message from the queue and sends it to the CTI server 102 (block 1406). The CTI server 102 eventually responds by sending the requested data associated with the call (UDataResp) to the CTI driver 218, which places the requested data on the queue (block 1408). The CTI server 102 may indicate that the data was received successfully (Success), that the data was for a call that does not exist (NoSuchCall), that the data does not match the call (NoMatch), that the feature is not supported by the CTI server 102 (FeatureNotSupported), or that a miscellaneous error occurred (MiscError). The queue handler 210 retrieves the response from the queue and sends the response to the message handler 208 (block 1410). The message handler 208 formats the response and sends the response to the client handler 206 (block 1412). The client handler 206 then sends the response to the client.

The following XML code is an example UDataGet message. The first five lines are similar to the first five lines of NoteCallInit described above. The sixth line indicates that the message is a UDataGet message and indicates the key associated with the destination of the request. The seventh line indicates the tag value associated with the data that is desired. The eighth line indicates the end of the UDataGet body. The ninth line indicates the end of the entire message.

| | |
|---|---|
| 1 | <?xml version=\′1.0\′ encoding=\′iso-8859-1\′?> |
| 2 | <!DOCTYPE GctiMsg SYSTEM \′/appl/genesys/IServer.dtd\′> |
| 3 | <GctiMsg> |

| | |
|---|---|
| 4 | <CallId>sida5011022034576a3f9cd456</CallId> |
| 5 | <TMS>0001</TMS> |
| 6 | <UDataGet Keys=’westenv:SWITCHTYPE’> |

| | |
|---|---|
| 7 | <RequestId>tscallid</RequestId> |

| | |
|---|---|
| 8 | </UDataGet> |

| | |
|---|---|
| 9 | </GctiMsg> |

The following XML code is an example UDataGetTx message. The first four lines are similar to the first four lines of UDataGet described above. The fifth through eighth lines are similar to the sixth through ninth lines of UDataGet described above. In other words, the UDataGetTx message is similar to the UDataGet message, but the TMS number has been removed.

| | |
|---|---|
| 1 | <?xml version=\′1.0\′ encoding=\′iso-8859-1\′?> |
| 2 | <!DOCTYPE GctiMsg SYSTEM \′/appl/genesys/IServer.dtd\′> |
| 3 | <GctiMsg> |

| | |
|---|---|
| 4 | <CallId>sida5011022034576a3f9cd456</CallId> |
| 5 | <UDataGetKeys=’westenv:SWITCHTYPE’> |

| | |
|---|---|
| 6 | <RequestId>tscallid</RequestId> |

| | |
|---|---|
| 7 | </UDataGet> |

| | |
|---|---|
| 8 | </GctiMsg> |

The following XML code is an example UDataResp response that was sent by the CTI server 102 in response to a UDataGet message. The first four lines are similar to the first four lines of NoteCallInit described above. The fifth line indicates that the UDataGet was successful. The sixth line indicates the start of the data that was requested by the UDataGet. Lines seven and eight provide the data that was requested by the UDataGet. The ninth line indicates the end of the data. The tenth line indicates the end of the UDataResp results. The eleventh line indicates the end of the response.

| | |
|---|---|
| 1 | <?xml version=′1.0′ encoding=′iso-8859-1′?> |
| 2 | <!DOCTYPE GctiMsg SYSTEM ′IServer.dtd′> |
| 3 | <GctiMsg> |

| | |
|---|---|
| 4 | <CallId>sida5011022034576a3f9cd456</CallId> |
| 5 | <UDataResp Result=’Success’/> |

| | |
|---|---|
| 6 | <UDataEx> |

| 7 | <Node Name=′westenv′ Type=′Str′ |
|---|---|
| | Val=′prd1′/> |
| 8 | <Node Name=′SWITCHTYPE′ Type=′Str′ |

Val=′MSL′/>

| | |
|---|---|
| 9 | </UDataEx> |

| | |
|---|---|
| 10 | </UDataResp> |

| | |
|---|---|
| 11 | </GctiMsg> |

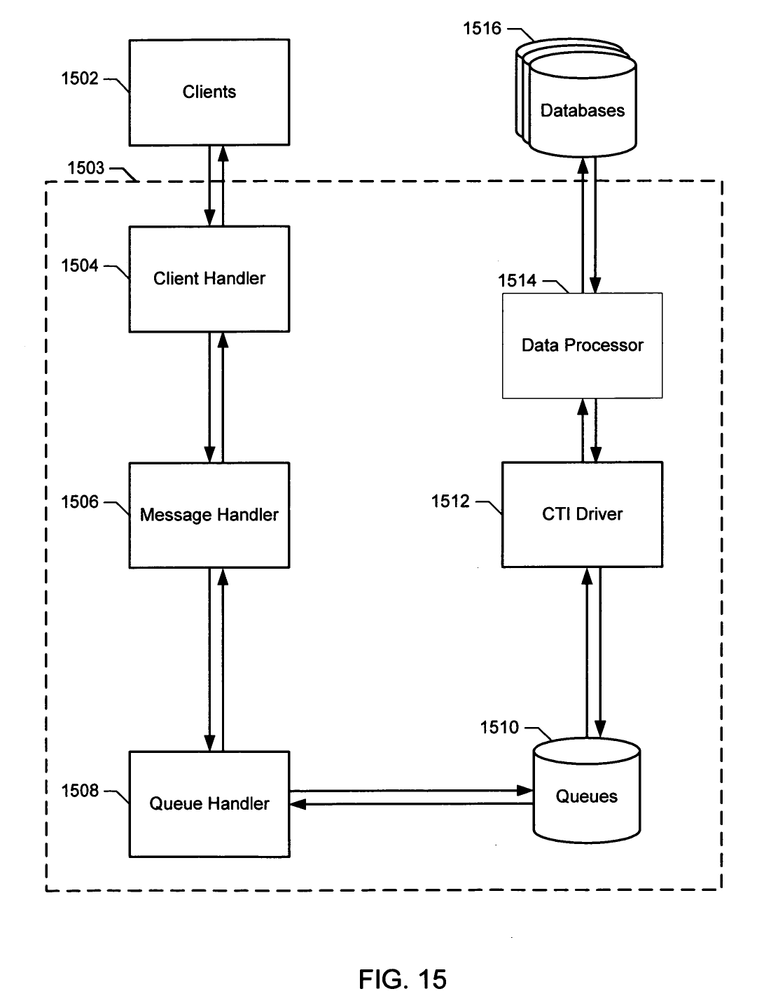

FIG. 15 is a block diagram of another example system for allowing multiple clients to connect to a CTI server simultaneously. The system of FIG. 15 includes clients 1502, a CTI server 1503, and a database 1516. The CTI server 1503 includes a client handler 1504, a message handler 1506, a queue handler 1508, queue(s) 1510, CTI driver 1512, and data processor 1514. The example system of FIG. 15 is similar to the example system of FIG. 2, but the components for receiving client messages from multiple clients have been integrated into the CTI server 1503.

The clients 1502 and databases 1516 are substantially similar to the clients 202 and databases 222 and, thus, are not further described herein.

The client handler 1504, message handler 1506, queue handler 1508, queue(s) 1510, and CTI driver 1512 are substantially similar to the client handler 206, message handler 208, queue handler 210, queue(s) 214, and CTI driver 218. Because these components are integrated into the CTI server 1503, the components may be directly connected to each other and, thus, no network connections may be necessary. Alternatively, the queue(s) 1510 may not be integrated in the CTI server 1503 and the queue handler 1508 and the CTI server 1512 may communicate with the queue(s) 1510 via one or more network connections.

The data processor 1514 is capable of receiving a message from the CTI driver 1512 and generating a response to the message. The data processor 1514 then transmits the response to the CTI driver 1512. The data processor 1514 may access the databases 1516 in order to generate a response to the message. For example, if a message requests information about an accounting record stored in the databases 1516, the data processor 1514 will parse the message to determine the purpose of the request, retrieve the requested data from the databases 1516, generate a response to the message, and send the response to the CTI driver 1512.

While FIG. 15 provides an alternative system, persons of ordinary skill in the art will recognize that the system of FIGS. 2 and 15 are not the only possible implementations.

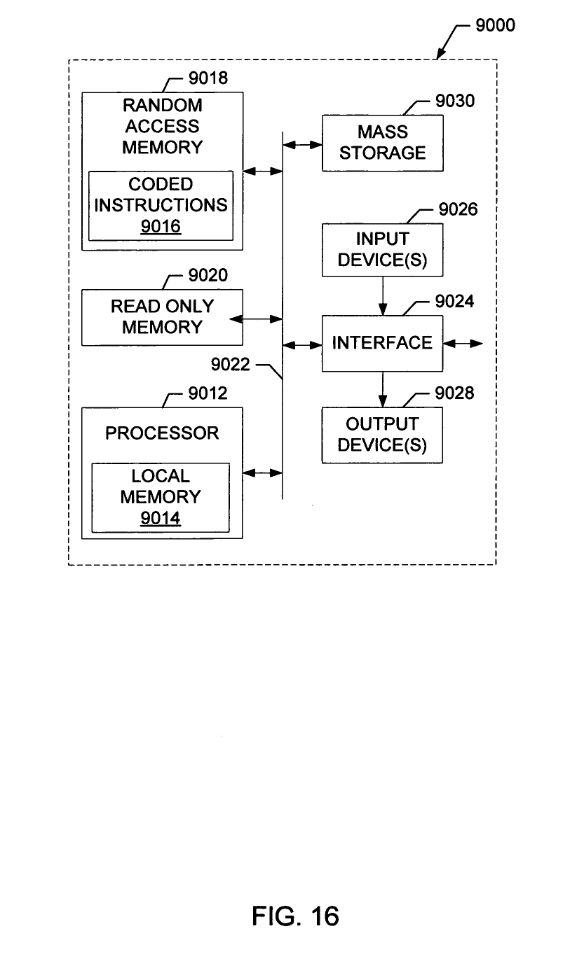

FIG. 16 is a block diagram of an example computer 9000 capable of executing the machine readable instructions represented by FIGS. 7 and 8 to implement the apparatus and/or methods disclosed herein. The computer 9000 can be, for example, a server, a personal computer, a personal digital assistant (PDA), an Internet appliance, a set top box, or any other type of computing device.

The system 9000 of the instant example includes a processor 9012 such as a general purpose programmable processor. The processor 9012 includes a local memory 9014, and executes coded instructions 9016 present in the local memory 9014 and/or in another memory device. The processor 9012 may execute, among other things, the example machine readable instructions illustrated in FIGS. 7-9. The processor 9012 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 9012 is in communication with a main memory including a volatile memory 9018 and a non-volatile memory 9020 via a bus 9022. The volatile memory 9018 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 9020 may be implemented by flash memory and/or any other desired type of memory device. Access to the main memory 9018, 9020 is typically controlled by a memory controller (not shown) in a conventional manner.

The computer 9000 also includes a conventional interface circuit 9024. The interface circuit 9024 may be implemented by any type of well known interface standard, such as an Ethernet interface, a universal serial bus (USB), and/or a third generation input/output (3GIO) interface.

One or more input devices 9026 are connected to the interface circuit 9024. The input device(s) 9026 permit a user to enter data and commands into the processor 9012. The input device(s) can be implemented by, for example, a keyboard, a mouse, a touchscreen, a track-pad, a trackball, isopoint and/or a voice recognition system.

One or more output devices 9028 are also connected to the interface circuit 9024. The output devices 9028 can be implemented, for example, by display devices (e.g., a liquid crystal display, a cathode ray tube display (CRT), a printer and/or speakers). The interface circuit 9024, thus, typically includes a graphics driver card.

The interface circuit 9024 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 9000 also includes one or more mass storage devices 9030 for storing software and data. Examples of such mass storage devices 9030 include floppy disk drives, hard drive disks, compact disk drives and digital versatile disk (DVD) drives.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general functionality. Accordingly, replacement standards and protocols having the same functions are equivalents which are contemplated by this patent and are intended to be included within the scope of the accompanying claims.

This patent contemplate examples wherein a device is associated with one or more machine readable mediums containing instructions, or receives and executes instructions from a propagated signal so that, for example, when connected to a network environment, the device can send or receive voice, video or data, and communicate over the network using the instructions. Such a device can be implemented by any electronic device that provides voice, video and/or data communication, such as a telephone, a cordless telephone, a mobile phone, a cellular telephone, a Personal Digital Assistant (PDA), a set-top box, a computer, and/or a server.

Additionally, although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A system comprising:
a client handler to receive messages from multiple clients;
a message handler to change the format of the messages;
a queue to store messages;
an interface to a telephony network;
a data processor to generate responses to messages;
a computer telephony interface (CTI) driver to retrieve messages from the queue and pass the retrieved messages to the data processor; and
a data storage to store data associated with the messages.

2. A system as defined in claim 1, further comprising a queue handler to store messages on the queue and to retrieve responses from the queue.

3. A system as defined in claim 1, wherein the message handler extracts multiple requests from one of the messages and generates a new message for each of the multiple requests.

4. A system as defined in claim 1, wherein the messages include a TMS number.

5. A system as defined in claim 4, wherein the message handler to remove the TMS number.

6. A system as defined in claim 1, wherein the data processor retrieves data from the data storage and inserts the data in the responses.

7. A system as defined in claim 1, wherein the system comprises a CTI server.

8. A method of allowing multiple clients to access a computer telephony interface (CTI) server having a telephony interface and a client interface, the method comprising:
receiving a first message associated with a call on the telephony interface from a first one of the multiple clients via the client interface;
storing the first message in a queue; and
when a connection to the CTI server is available, retrieving the first message from the queue and sending the first message to the CTI server.

9. A method as defined in claim 8, further comprising:
receiving a second message from a second one of the multiple clients;
storing the second message in the queue; and
when the CTI server finishes processing the first message, retrieving the second message from the queue and sending the second message to the CTI server.

10. A method as defined in claim 8, further comprising:
receiving a first response to the first message from the CTI server; and
sending the first response to the first one of the multiple clients.

11. A method as defined in claim 8, wherein the first message comprises two or more requests for the CTI server.

12. A method as defined in claim 9, further comprising:
extracting the two or more requests;
generating a new message for each of the two or more requests; and
storing the new messages in the queue.

13. A method as defined in claim 11, further comprising:
when a connection to the CTI server is available, retrieving a first one of the new messages and sending the first one of the new messages to the CTI server; and
when the CTI server finishes processing the first one of the new messages, retrieving a second one of the new messages and sending the second one of the new messages to the CTI server.

14. A method as defined in claim 8, wherein the first messages includes a TMS number.

15. A method as defined in claim 14, wherein the TMS number is removed from the first message before sending the first message to the CTI server.

16. A method as defined in claim 8, wherein the client interface comprises at least one of an Enterprise Java Beans interface, a Web Services Interface, a Simple Object Access Protocol interface, a servlet interface, a Hypertext Transfer Protocol interface, or a Java Messaging Service interface.

17. A method as defined in claim 8, wherein the first message is in an extensible markup language format.

18. A method as defined in claim 8, wherein the queue comprises a plurality of queues.

19. A method as defined in claim 18, wherein storing the first message in the queue further comprises:
determining a desired queue in the plurality of queues based on the content of the first message;
storing the first message in the desired queue.

20. A method as defined in claim 8, further comprising:
causing the first one of the multiple clients to wait for a response; and
after sending the first response to the first one of the multiple clients causing the first one of the multiple clients to stop waiting for a response.

21. A method as defined in claim 8, further comprising changing the format of the first response before sending the first response to the first one of the multiple clients.

22. A method as defined in claim 8, further comprising changing the format of the first message before sending the first message to the CTI server.

23. A method as defined in claim 8, wherein the first message includes an identifier associated with the call.

24. A method as defined in claim 10, wherein the response includes an identifier associated with the call.

25. A method as defined in claim 10, wherein the response is in an extensible markup language format.

26. An article of manufacture storing machine readable instructions which, when executed, cause a machine to:
receive a first message associated with a call on the telephony interface from a first one of multiple clients via the client interface;
store the first message in a queue; and
when a connection to a CTI server is available, retrieve the first message from the queue and send the first message to the CTI server.

27-43. (canceled)

44. A system of allowing multiple clients to access a computer telephony interface (CTI) server comprising:
a client handler to receive messages from the multiple clients;
a message handler to change the format of a message received from a first one of the multiple clients;
a queue handler to store the message received from the first one of the multiple clients in at least one queue; and
a CTI driver to retrieve the message from the at least one queue and to send the message to the CTI server.

45. A system as defined in claim 44, wherein the client handler is to send responses to the received message to the first client.

46. A system as defined in claim 44, wherein the message handler is to extract multiple requests from the message and to generate a new message for each of the extracted requests.

47. A system as defined in claim 44, wherein the message handler is to change a format of a response from the CTI server.

48. A system as defined in claim 44 wherein the queue handler is to retrieve a response from the at least one queue.

49. A system as defined in claim 44 wherein the CTI driver is to receive a response from the CTI server and to store the response in the at least one queue.

50. A system as defined in claim 44, wherein the multiple clients comprise at least one of an enterprise access service layer (EASL) client, a Perifonics (PERI) applications client, or a call setup application.

51. A system as defined in claim 44, wherein the CTI server is a Genesys I-server.

52. A system as defined in claim 44, wherein the queue is a MQ Series queue, a Tuxedo database, one or more files, or a TCP/IP stack.

53. A system as defined in claim 44, wherein at least one of the client handler, the message handler, the queue handler, or the CTI driver are application written in the Java programming language.

54. A system as defined in claim 44, wherein the message handler is to remove a TMS number from the message.

55. A system as defined in claim 44, wherein at least one of the client handler or the CTI driver is to log at least one of changes made to the message, a transmission of the message, a reception of the message, or an error in the message.

56. A system as defined in claim 44, further comprising a CTI server to receive a message from the CTI driver and to transmit a response to the CTI driver.
